(19) United States
(12) Patent Application Publication
(10) Pub. No.: US 2004/0052476 A1
(43) Pub. Date: Mar. 18, 2004

(54) Method and device for mechanically fixing an optical component

(76) Inventor: Patrice Houmault, Toulon (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/250,515

(22) PCT Filed: Dec. 26, 2001
(86) PCT No.: PCT/FR01/04201

(30) Foreign Application Priority Data
Dec. 28, 2000 (FR) 00/17202
Feb. 9, 2001 (FR) 01/01804

(51) Int. Cl. G02B 6/36

(52) U.S. Cl. 385/88; 385/33

(57) ABSTRACT

The present invention relates to a method and to a device for securing an optical component to a mechanical structure. The technical field of the invention is that of manufacturing optical systems based on optical fibers. According to the invention, said component (2) is engaged in a deformable mount (3), said mount (3) is then deformed to secure it to said component (2), and said mount (3) is kept deformed by a ring (4) surrounding said mount (3).

The present invention relates to a method and a device for securing an optical component to a mechanical structure.

The technical field of the invention is the manufacture of optical systems, in particular those based on optical fibers.

The present invention applies to all types of optical component, whatever their dimensions or shape, in particular to all components of cylindrical, spherical, or rectangular shape, in particular to lenses, microlenses (of diameter of millimeter order or smaller), windows, optical fibers (of diameter of the order of one hundred microns to several hundred microns), optical fiber collimators, filters, mirrors, and insulators. It also applies to components laid out in parallel or in matrices like flat sheets of fibers and arrays of lenses.

Many optical systems require optical components to be aligned and fixed in definitive manner. In telecommunications, for example, systems which perform optical or optoelectronic functions, such as emitters, receivers, switches, wavelength-division multiplexers/demultiplexers, circulators, interleavers, attenuators and amplifiers, are designed to be integrated definitively (i.e. until the end of their lifetime) in an optical fiber network, which is buried underground (in the case of a connection on land) or placed under the sea (in the case of an underwater connection). The various optical components of those systems must thus be aligned and fixed in permanent manner. Any inopportune misalignment must be avoided since that would cause performance to deteriorate over time. The support of those components must thus be sufficiently rigid.

In many cases, the optical components permitting, in order circumvent any problem of contamination or mold due to the outside environment, and following proper alignment with one another, to produce the desired optical function, the optical components are placed in a package which is heliumtight or watertight, or they are placed on the package when the components provide a through passage to the external medium.

Some of those optical and optoelectronic systems in hermetically-sealed packages are equipped with an optical fiber, having one end located inside the package and its other end outside, with the passage through the side of the package being achieved by means of a ferrule in which the optical fiber is assembled. Sometimes, the hermetically sealed feedthrough comprises a mount that includes other optical components such as subassemblies of lenses and fiber ends. In all cases, hermetic sealing or watertightness must thus be ensured, not only between the mount of the component and the package, but also between the component and its mount.

Optical telecommunications are mentioned as a field of application. There are other applications, such as, in particular, optical memories, multimedia, military and medical optroelectronics, laser printing, or bar code readers.

In some of those applications, optical systems are manufactured in large quantities so the production method needs to be simple and cheap, with the possibility of automation, while preserving satisfactory optical performance and ensuring heliumtight or watertight fixing, where necessary.

The invention applies to many optical components, including lenses, optical fibers, filters, optical fiber collimators, insulators, windows, mirrors, arrays of lenses, and flat sheets of fibers; the invention also applies to assembling together a plurality of components such as an optical fiber and a lens, two lenses, a collimator and a wavelength filter.

The fixing of such optical components, in particular those made of silica or plastics material, in a mechanical structure—or mount—, is difficult.

Fixing with adhesive is difficult to apply automatically and the constituents of the adhesive could contaminate the optical component and/or its mount, as well as other components located near to the glued part. Certain optical components (laser diodes and photo detectors, for example) are prone to degradation by the action of those constituents. Moreover, it is not possible to ensure a perfect hermetic connection between the component and its mount using that method of fixing; unfortunately, when components and optical fibers are used for telecommunication systems, it is often necessary to ensure heliumtightness for such a connection.

Alternatively, such components and optical fibers can be metallized at their peripheries and then brazed in the mount (using a binding agent); that method of fixing by brazing is expensive and difficult to implement in automated manner.

In the two above-mentioned techniques, it is necessary to provide a space between the optical component and the mount to receive the adhesive or the binder. That space can sometimes generate detrimental misalignment of the component in its mount.

Patents U.S. Pat. No. 5,305,406 and U.S. Pat. No. 5,822,483 describe an optical fiber connector which comprises a metal core onto which an epoxy body is molded; one or more optical fiber(s) extend inside the core, which is (are) crimped at one end; the crimping is achieved by deforming one end of the core by impact from a conical tool (flared).

That method of crimping by impact does not allow the deformation of the core to be precisely controlled; consequently, the clamping force exerted by the deformed core on the optical fiber cannot be controlled using that method; moreover, that method cannot be used with certain metals constituting the core. In addition, the length of attachment between the core and the fiber cannot be correctly controlled, nor can the extra pressure generated on the fiber at the moment of impact.

The object of the present invention is to propose a method and device for fixing such components and optical fibers to structures securely and definitively, to form an optical fiber connector for example, or a feedthrough in a partition, and which resolve, partly at least, the known disadvantages of techniques for fixing such components.

An object of the invention is to propose such methods and devices which are inexpensive, easily automated, simple, rapid and easy to implement, utilizable for various types of components, and do not require components and mounts to be used of shape complying with dimensional tolerances that are excessively strict.

Another object of the present invention is to propose such a device in which, if necessary, the component and the mechanical structure may be heliumtight or watertight, so that the device can be used as a feedthrough in a hermetic or watertight wall.

Another object of the invention is to propose a device whose manufacturing and assembly parameters can be controlled.

Another object of the invention is to propose a method and device allowing good alignment of the component in its mount.

In a first aspect of the invention, in order to fix an optical component to a structure, the component is engaged in a deformable mount, which is subjected to deformation, generally in compression, until it is secured to the component, and the mount is maintained in the deformed state by a ring surrounding the mount; the mount or the ring can then be fixed to the structure.

In other words, the invention applies to a method of fixing an optical component into a cavity present in a first part—known as a mount—, by deforming the first part and swaging the cavity until the component is fixed by friction to a face of closed outline, in particular a cylindrical face defining the cavity at least in part. According to the invention, a second part comprising—or essentially constituted by—a ring clamping on the first part in such a manner as to cause and/or maintain said swaging, is engaged around at least a portion of the first part; this engaging simultaneously assembles the component with said first and second parts by friction between the component and the first part, and by friction between the first part and the second part.

To this end, the second part clamps on the first part at (i.e. around) the zone of connection by friction between the component and the first part.

Preferably, the material constituting the mount has a low elastic limit so that said mount can be deformed easily.

The elastic limit is taken to mean the stress on stretching which, when applied to a test piece, causes residual lengthening (measured after the stress has returned to zero) equal to 0.2% of its initial length. When the residual lengthening is greater than 0.2%, the material is considered to be no longer elastic: it has entered a plastic phase. There are other definitions, which give similar results.

Nevertheless, the elastic limit can reach high values when the optical component must be held with force. Thus, as an example, the relatively hard materials used for mounts can have elastic limits greater than 15 megapascals (MPa), possibly 50 MPa, 70 MPa, 100 MPa, or even 170 MPa. Preferably said mount is made of metal. It comprises (or essentially consists of) a sleeve having an outside surface on which the ring exerts a compressive force which causes radial (and centripetal) deformation of the sleeve (and/or mount); as a result of this deformation, the inside surface of the mount is brought into contact with the outside surface of the optical component, and consequently, the component and its mount are secured to each other by friction (and/or by wedging).

Preferably, said compression forces are obtained by thrust exerted on the outside surface of the mount by the inside surface of the surrounding ring clamping said sleeve and/or said mount. Preferably, at least one of said surfaces, outside for the mount or inside for the ring, is flared. Preferably, one of said outside or inside surfaces is substantially conical in shape, the other surface also being substantially conical in shape and of the same taper; alternatively, this other face is cylindrical in shape. To this end, the half angle in the center of said flared or sloping (in particular conical) surface(s) is less than 45°, preferably about 0.3° to 10°, in particular about 0.3° to 3°; so as to facilitate the compression of the mount due to the pressure exerted by the ring, said mount is preferably made of a material that is at least as ductile as that of said ring, in particular of a material based on copper, zinc, iron, aluminum, nickel, lead, tin, indium, or a plastics-based material, and/or said mount is selected to be of thickness no greater than that of said ring.

As an alternative, said outside surface of the mount and said inside face of the ring may be cylindrical.

In order to ensure that said ring causes compression of the mount, i.e. reduces its diameter or radial dimensions by the mutual thrust of their respective contacting (conical or cylindrical) faces, said ring is placed on the same axis as said mount and is then displaced relative to the mount, preferably in translation along the longitudinal axis generally coinciding with the axis of revolution common to the bearing faces of the mount and the ring; this movement can be obtained by a press, whose punch presses on the ring, and whose anvil forms an abutment for the mount.

Although allowing the mount to deform, the material and dimensions of the ring are preferably selected so that when the mount comes into contact with the component, the ring can be deformed radially (i.e. in the plane perpendicular to its axis of revolution) sufficiently to absorb part of the stresses and avoid buckling and rupturing the mount, or even rupturing the component.

Alternatively, swaging of the mount surrounding the component to secure them mutually can be obtained by cooling said mount; for this purpose, the mount is preferably previously heated so that it expands and can be placed around the component to which it is to be fixed.

Similarly, when the tolerance on the diameter of an optical component is insufficient, so that the optical component is over-sized and unable to fit into its mount, a hot interference-fit operation can be carried out: the mount is heated to a temperature such that it expands sufficiently to allow the optical component to be inserted. After cooling, the component is held captive in its mount.

In another embodiment of the invention, a mount can be placed around the optical component, which mount has an inside face that is adjusted to slide along the component with limited clearance, then a ring previously expanded by heating, and sliding with limited clearance around the mount is placed around the thin mount; the ring is then swaged by cooling, for example, so that the ring radially compresses the mount against the periphery of the component until all three parts are mutually secured.

Thus, the invention is based partly on the surprising observation whereby it is possible to secure the mount to an optical component by shrinking the mount and crimping around the component, without significantly spoiling the optical characteristics of the component; indeed, contrary to what might be predicted, the mechanical stresses applied to the optical component under the effect of interference fitting the ring and swaging the mount, do not lead to a significant modification of the optical characteristics of the component when they are sufficiently weak and/or when they are radial and uniform (in the case of an optical component of cylindrical or spherical outline for example).

Preferably, with optical components of cylindrical or spherical shape, in order to avoid spoiling the optical characteristics, a circularly symmetrical mount is used capable of clamping on the component by exerting force uniformly over its entire periphery.

The invention is also based on the surprising observation whereby when the cavity of the mount is of a shape and dimensions close to those of the component to be clamped, it is possible to obtain heliumtight and watertight sealing between the component and said mount and possibly between the ring and mount, and this, even for small-sized components like optical fibers (0.125 mm diameter) or small lenses (often called microlenses when they have diameters in the order of 1 mm or less).

With the same aim, the mount used preferably has a large (generally cylindrical) bearing surface in contact with the component so that the clamping forces are distributed over the surface and the stresses resulting from the compression of the mount are kept low; tests have shown that satisfactory results are obtained for an interference-fit zone between the mount and the component of length (measured along the longitudinal axis of the component) having a value lying in the range of 100 microns (μm) to 3000 μm.

The invention allows a precise, reliable, heliumtight or watertight mechanical connection to be obtained with good reproducibility, without brazing or adhesive, and which can be used equally well for various types of optical component, by minimizing the risks of degrading or destroying the components during the implementation of the method.

Other advantages and characteristics of the invention appear from the following description which refers to the accompanying drawings, which show preferred embodiments of the invention as non-limiting examples.

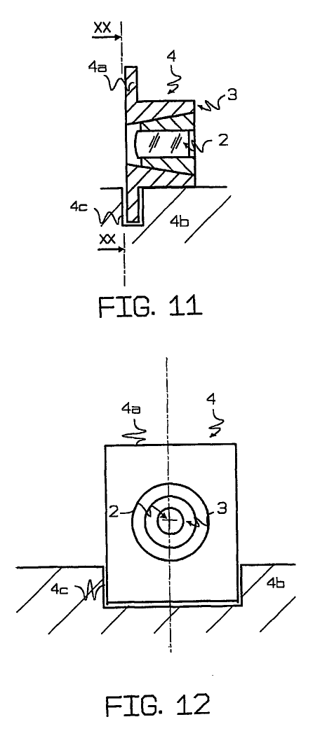

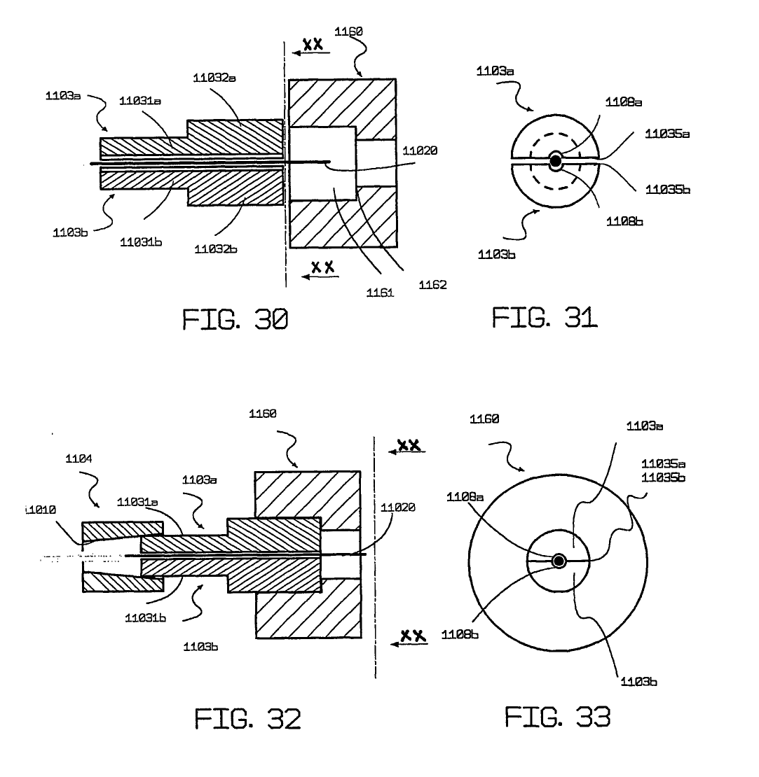

Apart from FIG. 29 and FIGS. 12, 28, 31, 33, 35, and 37 (which are section views on plane XX-XX of FIGS. 11, 26, 30, 32, 34, and 36 respectively), FIGS. 1 to 42 are longitudinal section views on the plane containing the optical axis 1 of the optical component to be fixed to a structure.

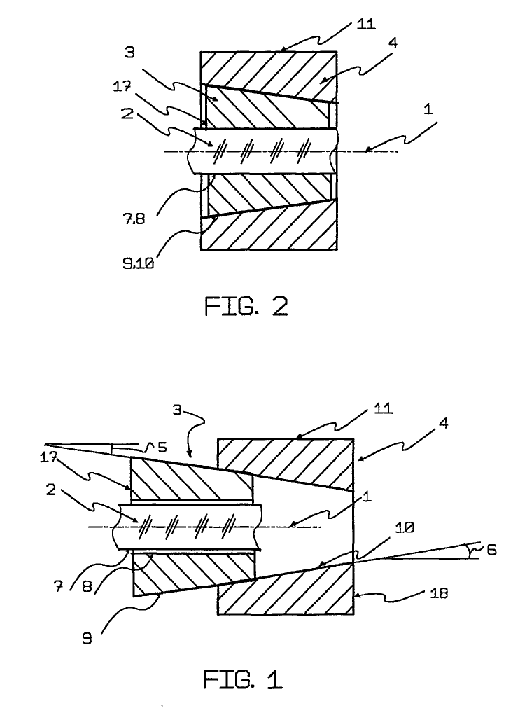

FIGS. 1 and 2 are diagrams showing a system for mechanically fixing an optical component of cylindrical envelope, respectively before mounting and after mounting in accordance with the invention.

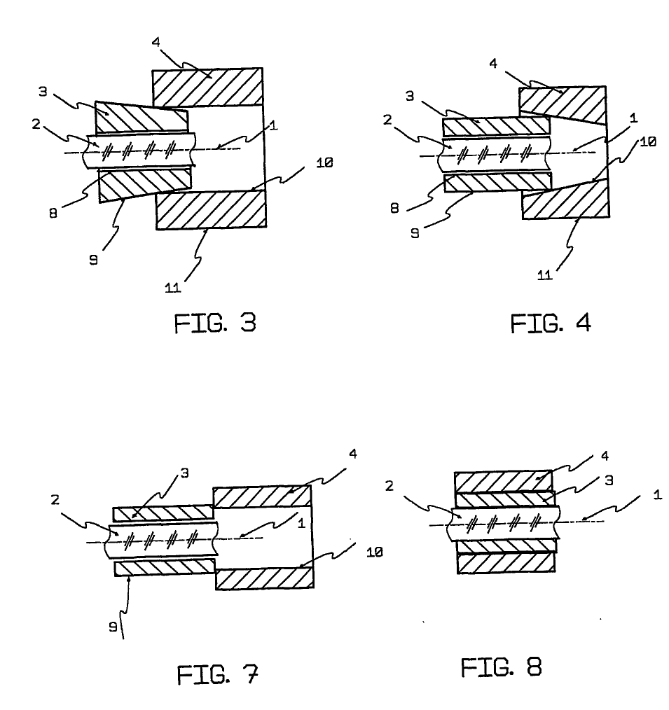

FIGS. 3 and 4 show respective variants of the system of the invention as shown in FIGS. 1 and 2, before assembly of the system.

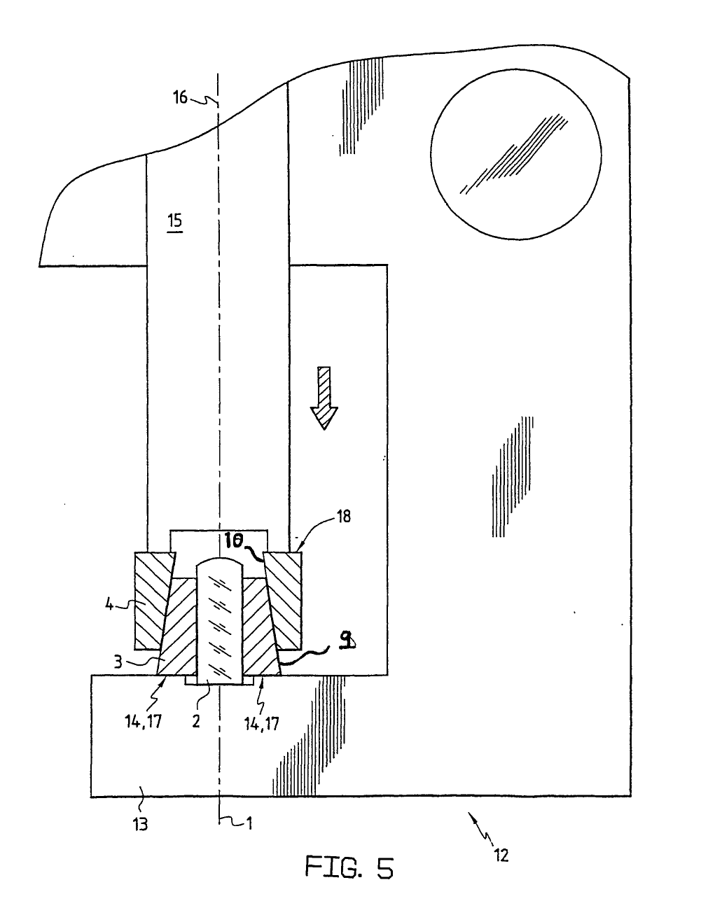

FIG. 5 is a diagrammatic longitudinal section view showing an optical component, a mount, and a ring being assembled together simultaneously using a press.

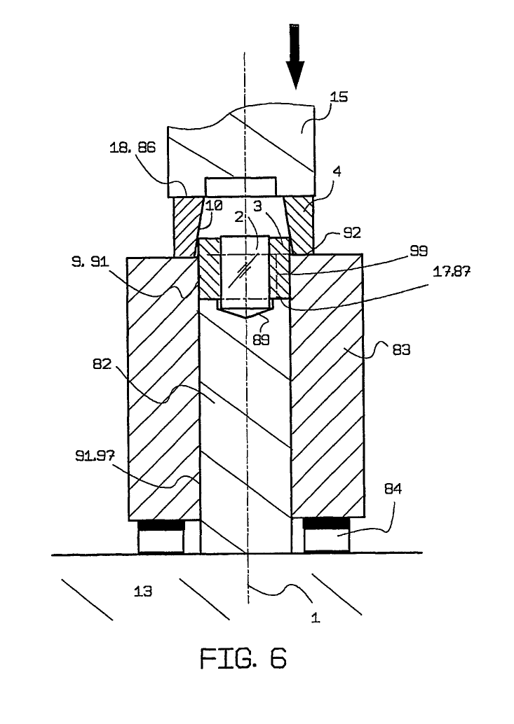

FIG. 6 shows an improvement of the assembly system of FIG. 5 adapted to cylindrical mounts, enabling them to be guided.

FIGS. 7 and 8 show a variant of the system of the invention before and after mounting, respectively, in which the ring and mount are cylindrical.

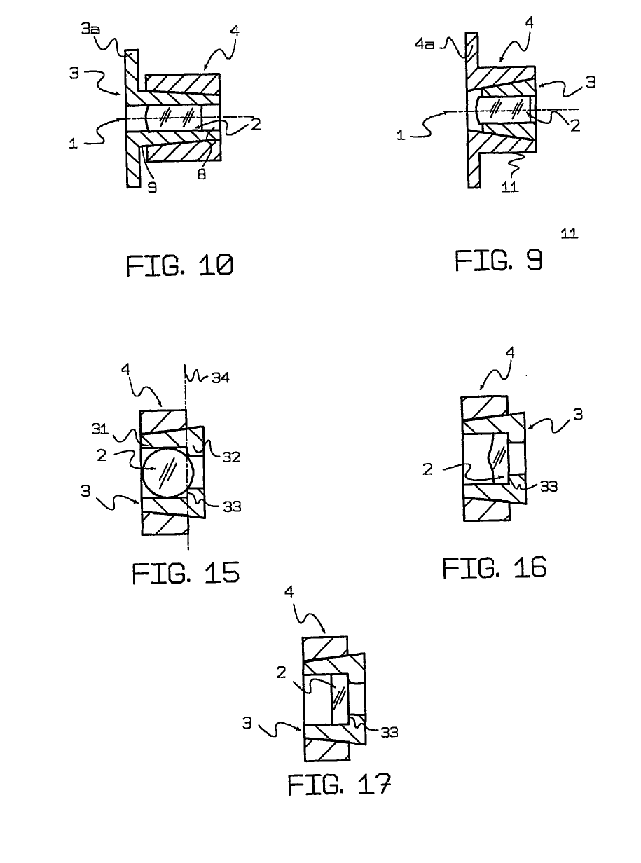

FIGS. 9 to 12 show three embodiments of the invention applied to a thick lens of cylindrical outline whose mount or ring includes a flange.

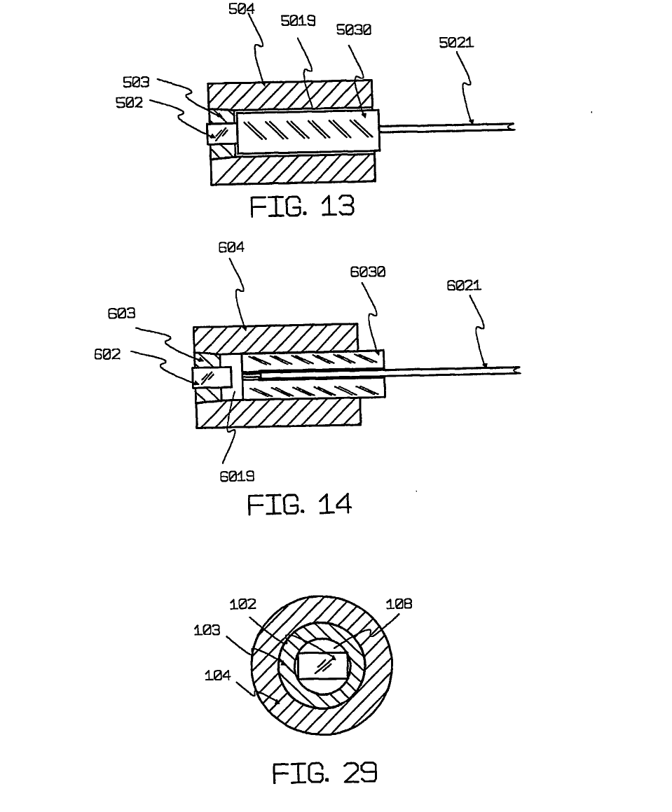

FIGS. 13 and 14 show two examples of the system of the invention adapted to a thick lens and in which the ring is designed to receive a ferrule or a capillary tube housing a fiber.

FIGS. 15 to 17 show three variants of an embodiment of the invention applied respectively to a spherical lens, to a thin cylindrical lens, and to a window, in which the mount is provided with an abutment for stopping displacement of the lens.

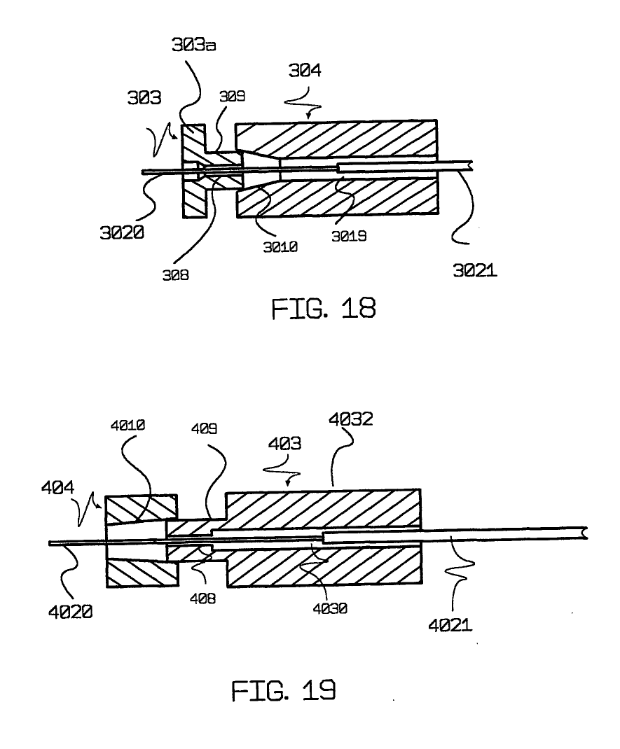

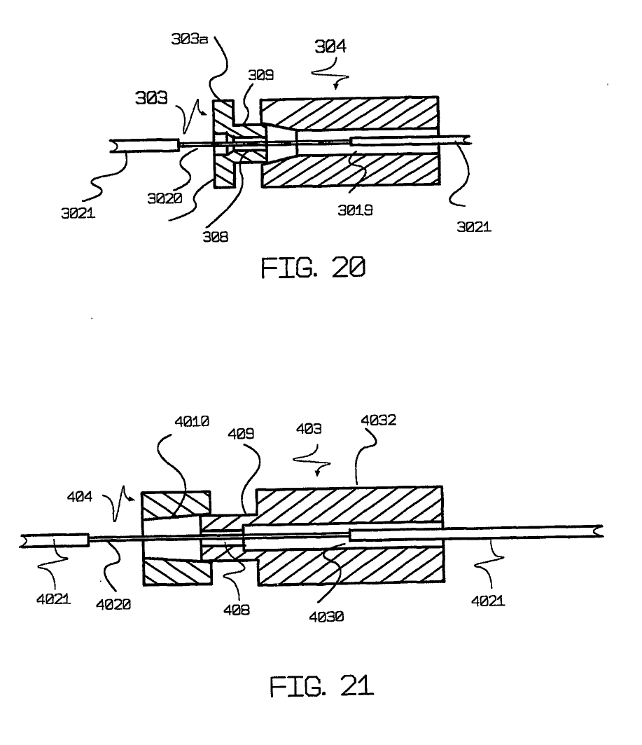

FIGS. 18 to 21 each show an alternative use of the invention to crimp a ring onto the end of an optical fiber (FIGS. 18 and 19) and between two portions of an optical fiber equipped with a protective sheath (FIGS. 20 and 21).

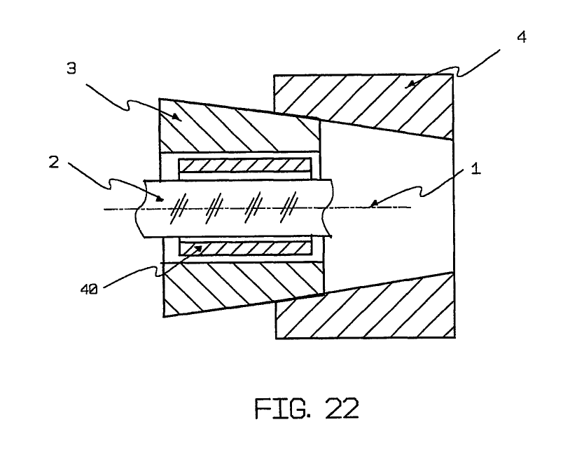

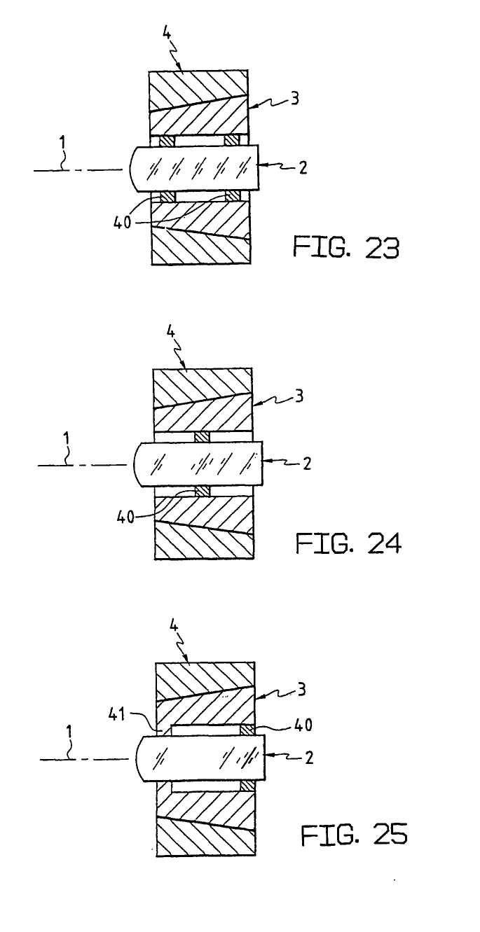

FIGS. 22 to 25 show embodiments of the invention in which there are placed, in between a lens and its mount: a long deformable ring (FIG. 22); two short deformable rings (FIG. 23); a short deformable ring (FIG. 24); and a short deformable ring in which the mount has an annular projection (FIG. 25).

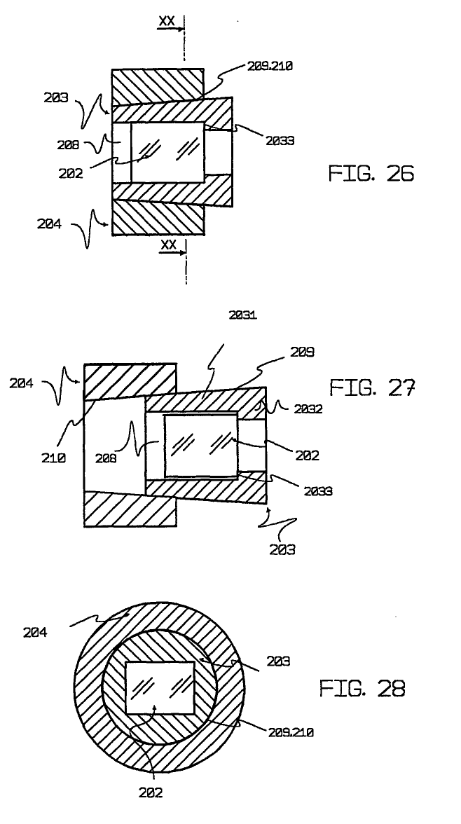

FIGS. 26 to 28 show an adaptation of the principle of the invention to a component of rectangular shape.

FIG. 29 shows another adaptation of the principle of the invention to an optical component of rectangular shape, in which the mount has a cylindrical cavity.

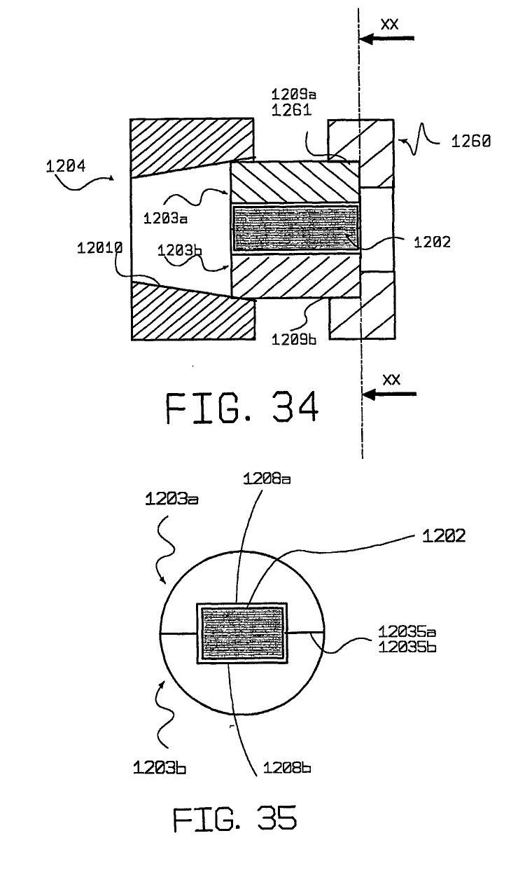

FIGS. 30 to 35 show a variant embodiment of the invention in which the mount is in two parts, FIGS. 30 to 33 showing an application to an optical fiber, FIGS. 34 and 35 showing an application to optical components of rectangular shape.

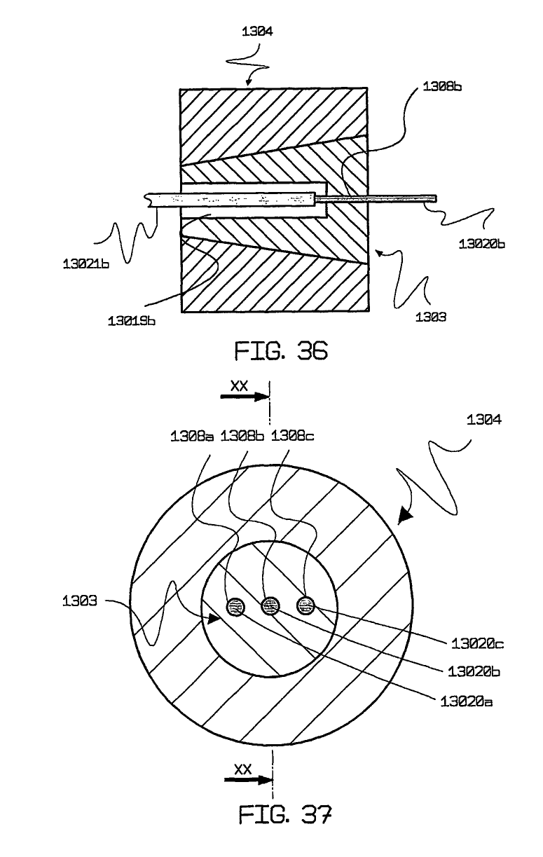

FIGS. 36 and 37 show an embodiment of the invention in which the mount includes three cavities housing three optical fibers.

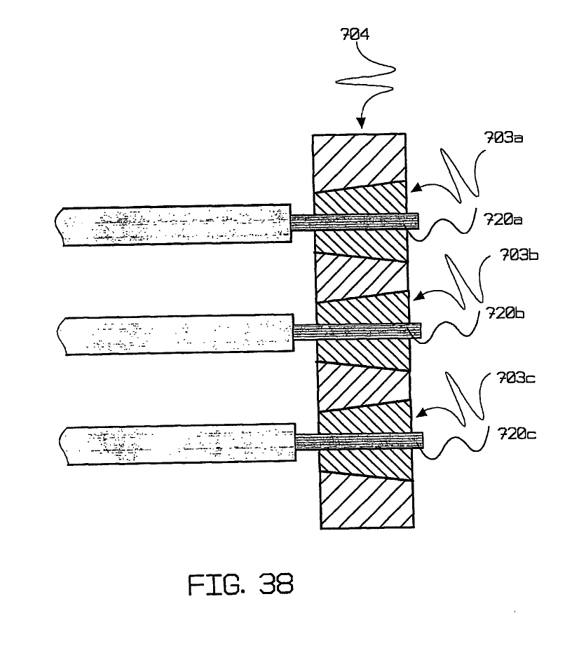

FIG. 38 shows another variant of the invention applied to three optical fibers, in which three mounts are set in a wall.

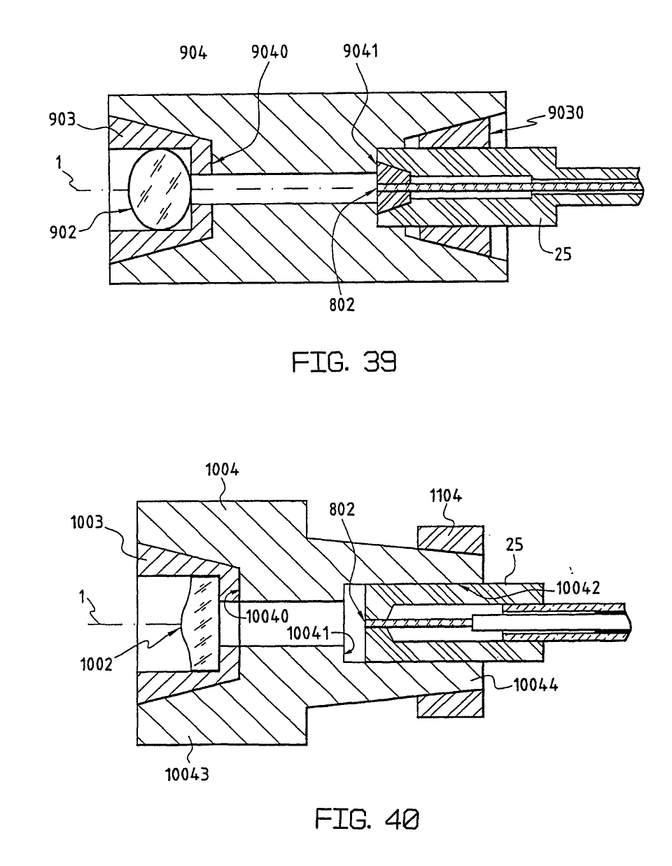

FIGS. 39 to 41 show three alternative embodiments of an assembly enabling the end of an optical fiber to be secured to and aligned with a lens.

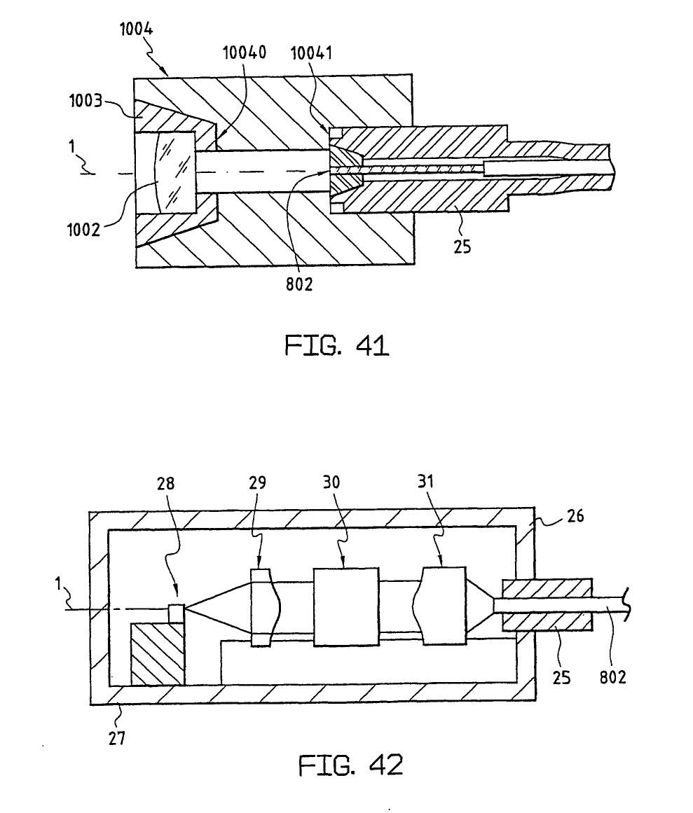

FIG. 42 shows the use of an assembly of the invention to feed an optical fiber hermetically through a wall of a sealed package containing a laser emitter.

With reference to FIGS. 1 and 2, the optical component 2 of optical axis 1 has a peripheral face 7 of cylindrical shape about the axis 1; the mount 3 is of annular shape and has a cylindrical inside face 8 and a frustoconical outside face 9, extending about the axis 1 and with a half angle 5 at the apex (of the cone) equal to 1° or 2° for example; the ring 4 is also of annular shape and has an inside face 10, which is of frustoconical shape about the axis 1 and with a half angle 6 equal to the half angle 5; the ring 4 has an outside face 11 that is cylindrical about the axis 1.

FIGS. 3 and 4 show respective embodiments of the invention before assembly applied to an optical component 2 of cylindrical shape and of optical axis 1.

In FIG. 3, the ring 4 and the mount 3 are annular in shape. The outside face 9 of the mount is frustoconical, whereas its inside face 8 is cylindrical. The inside face 10 and outside face 11 of the ring are both cylindrical. The diameter of said cylindrical inside face 10 of said ring is in the range between the major and the minor diameters of the frustoconical outside face 9 of said mount 3.

In FIG. 4, the mount 3 is annular and its inside face 8 and outside face 9 are both cylindrical. The ring 4 is also annular, its inside face 10 being frustoconical and its outside face 11 being cylindrical. The diameter of said cylindrical outside face 9 of said mount is in the range between the major and the minor diameters of said frustoconical inside face 10 of said ring 4.

FIG. 5 shows an assembly system for a device similar to that shown in FIGS. 1 and 2 but also applies to a device as shown in FIGS. 3 and 4.

With reference to FIG. 5, the press 12 comprises a fixed base 13 and a punch 15 movable in translation along the vertical axis 16 relative to the base.

The optical component 2 and the mount 3 are placed on the base 13, the mount 3 encircling the optical component while being able to slide freely (with very limited clearance) along it, and along optical axis 1; the axes 1 and 16 preferably coincide substantially, and the flat lower face (such as that marked 17 in FIG. 1) of the mount 3 is placed on a flat annular supporting face 14 of the base 13; the ring 4 is engaged by sliding it around the mount 3 until its conical inside face 10 makes contact with the conical outside face 9 of the mount 3; the punch 15 is displaced downwards along axis 16, its lower end pressing on the upper face 18 of the ring 4; this causes flattening and shrinkage of the mount 3 around the optical component 2, and blocking by wedging (setting) of the ring 4 around the mount 3, resulting in all the three parts 2, 3 and 4 being mutually secured in irreversible manner.

Depending on circumstances, once the device has been assembled, the mount or the ring can be fixed to the structure.

In order to monitor continuously the thrust of the punch on the ring and to control the interference fitting of the parts 2, 3, 4, a force sensor (not shown) can be inserted between the face 17 of the mount 3 and the face 14 of the base 13, and can be connected to a meter or to signal processing means suitable for stopping the displacement of the punch when the applied pressure has reached a predetermined limit.

If necessary, when the ring is made of metal, its shape and its dimensions can be selected so that the stresses to which it is subjected for given penetration are above the elastic limit of the material from which it is made; the stresses on the component and its mount are then largely independent of the tolerances on their respective diameter(s), that of the ring, and those on any cone angles.

For given penetration, the stresses imposed by the ring on the mount and on the component can thus lie within a range which ensures the required mechanical strength and, where necessary, heliumtightness and watertightness, without breaking the optical component. This mounting system requires a punch abutment (not shown) to put a limit on the longitudinal displacement of the ring relative to the mount, said longitudinal displacement being stopped by said abutment as soon as the predetermined limit is reached. The use of a force sensor is then not useful.

By way of an example, a cylindrical lens (of glass), 3 mm in length and 1.25 mm in diameter (tolerance: +5 microns/−10 microns), was placed in a brass mount bored with the same diameter (tolerance: +5/+15 microns); a brass ring with a conical bore (taper 2° and 3 mm outside diameter) was installed around the conical outside face (of the same taper) of the mount, until the faces came into contact; an axial force lying in the range 150 newtons (N) to 600 N was applied to secure the three parts mutually by friction. The radial deformation (which in this case is an expansion measured perpendicularly to the optical axis of the component) of the ring can reach 0.05 mm, which represents 1.65% of its outside diameter. These results show that certain stresses which are imposed on said ring are (in this example) above the elastic limit of the material of which it is constituted (indeed, when all the stresses are no greater than the elastic limit, the relative deformation is substantially lower than 1% or even 0.5%).

In another embodiment, the same lens was placed in the same brass mount as in the previous example. The ring whose inside face had a taper of 2° and an outside diameter of 2 mm was made of stainless steel. Its radial expansion, after penetration, could be as great as 0.1 mm, which represents 5% of its outside diameter; this result shows that, in this case also, the stresses imposed on the ring can exceed its elastic limit (which, when reached, is accompanied by a relative lengthening of less than 1% or even 0.5%). The use of an aluminum ring of the same shape gave similar results.

If necessary, in order to increase the ductility of the mount, when made of metal, in order to improve the heliumtightness of the interface between the optical component and the mount and/or in order to minimize the stresses on the component, said mount could previously be plated with a metal deposit, preferably goldplated.

In a variant of the embodiment shown in FIGS. 7 and 8, the mount 3 and the ring 4 are of (cylindrical) tubular shape and hollow; the cylindrical optical component 2 can slide with limited clearance in the mount 3; after compressing the ring and mount, the three parts 2, 3, 4 are definitively secured; preferably, when the mount and the ring are cylindrical, the diameters of the outside face 9 of the mount and of the inside face 10 of the ring are designed to allow a force fit of the ring around the mount, to compress the mount and cause all three parts 2, 3, 4 to be secured simultaneously.

The ring 4 could alternatively be preheated until the mount 3 can be inserted therein by sliding. Said ring contracts during cooling, causing the mount to flatten and secure the component 2.

The principle of the mount system shown in FIG. 6 is an improvement of the setting principle of FIG. 5 and applies to a device as shown in FIGS. 4, 7 or 8.

Thus, the outside face 9 of mount 3 is cylindrical. A support 82 that is also cylindrical, of vertical axis and substantially coinciding with the axis 1 of the optical component 2 is interposed between the mount 3 and the base 13 of the press. The flat lower face 17 of the mount 3 is placed on an annular face 87 of said support, the optical component, inserted by sliding in said mount rests against an abutment 89 of the same support. The diameter of the outside face 9 of the mount 3 is approximately equal to that of the outside face 97 of the support 82. The sleeve 83 is of annular shape, the diameter of its cylindrical inside face 91 being very slightly greater than that of the support 82 and of the outside face 9 of the mount 3; thus, said sleeve 83 slides with very limited clearance (not shown in the figure) around the mount 3 and the support 82. The conical inside face 10 of the ring 4 is brought into contact with the outside face 9 of the mount. An elastic element 84 resting on the base 13 pushes the sleeve 83 upwards against the flat lower face 92 of said ring 4; consequently, said sleeve encircles the part 99 of the mount 3 located under said flat lower face 92 of the ring.

The mount is constantly guided longitudinally by the sleeve and thus cannot sag or buckle while the optical component is being secured to the ring by downward movement in translation of the punch 15, whose annular lower face 86 is in contact with the upper face 18 of said ring.

In the embodiment shown in FIG. 9, the optical component 2 is a thick cylindrical lens of optical axis 1. The ring 4 contains a frustoconical cavity and a thin cylindrical outside face 11 extended by a cylindrical flange 4a which serves to increase the bearing surface area of the punch and, optionally, to fix said ring to a mechanical structure by adhesive, welding, or brazing. The mount 3, of annular shape, whose outside face is frustoconical with the same taper as the cavity of the ring, is fitted therein by force, its cylindrical inside face enclosing the lens.

In the embodiment shown in FIG. 10, the thick and cylindrical lens 2 of optical axis 1 is housed in a cylindrical bore 8 of the mount 3. This has a frustoconical outside face 9 extended by a flange 3a whose role is to increase the bearing surface area on the base during the assembly and also to fix said mount on a structure. The ring 4 is of annular shape and has a frustoconical cavity with the same taper as the outside face of the mount. It is force fitted onto the mount, which encloses the lens 2.

FIGS. 11 and 12 show an alternative embodiment shown in FIG. 9 in which the flange 4a of the cylindrical ring 4 has a square outline adapted to the shape of the housing 4c provided in a structure 4b with which the ring can thus be secured.

In the embodiment of FIG. 13, an optical fiber collimator comprises one end of an optical fiber 5021 and a thick cylindrical lens 502 held together in a cylindrical capillary tube 5030 by adhesive or some other fixing method. The front part of the lens 502 is outside the capillary tube. It is fixed to the front of the ring 504 by an interference fit of said ring 504 and swaging of the mount 503. The ring has the shape of a tube extended at the back by a cylindrical bore 5019 housing the capillary tube.

In the embodiment of FIG. 14, the mount 603 which clamps the thick and cylindrical lens 602 is set in a (conical) flared cavity of the ring 604 whose outline is cylindrical. Said flared cavity is extended at the back by a cylindrical bore 6019 housing a cylindrical ferrule 6030, containing the end of an optical fiber 6021. When the ferrule is suitably positioned and fixed in the bore 6019 of the ring by adhesive or another method of fixing, the complete device can collimate/focus an optical beam coming from the fiber, or can focus an optical beam onto the fiber.

In FIG. 15, the component is a spherical lens 2. Due to the action of the ring 4, a narrow part 31 of the mount 3 clamps onto the outline of the lens 2 and extends (longitudinally) beyond it in the form of a wider part 32; the mount includes a flat face 33 extending in a plane 34 which is orthogonal to axis 1; this plane constitutes a frontier between said narrow part 31 and wide part 32 of the mount; face 33 serves as an abutment and a support for the lens 2. The accuracy of the longitudinal positioning of the lens in the mount is thereby improved and assembly is facilitated.

In the embodiments shown in FIGS. 16 and 17, the optical component 2 has a thin cylindrical outline. Its entire periphery is clamped by the narrow part 31 of the mount 3 due to clamping of the ring 4. It abuts on face 33, which serves as a frontier between the narrow part 31 and the wider part 32 of said mount.

In FIG. 16, the optical component is a lens; in FIG. 17, it is a window with flat faces.

An optical fiber consists of a light-conducting core and optical cladding. The cladding may also act as a protective sheath.

In the case of an optical fiber for telecommunications applications, the core and cladding are silica-based. The cladding is covered with a protective sheath, generally of acrylate, which may also be covered with a mechanical sheath (often called a buffer).

With reference to FIG. 18, the mount 303 consists of a cylindrical cavity 308 partially housing the cladding 3020 at the end of an optical fiber. The diameter of the cavity 308 is very slightly greater than that of the cladding 3020 thereby allowing it to slide. The cylindrical outside face 309 of the mount presses against the flared inside face 3010 of the ring 304, so that once set in said ring, the mount clamps onto the cladding. The ring has the shape of a tube (ferrule) whose (frustoconical) flared inside face is extended at the back by a cylindrical bore 3019 in which the protective sheath 3021, and possibly also the buffer of the optical fiber (not shown), can extend in part. The cylindrical outside face 309 of the mount 303 is extended, at the front, by a flange 303a which facilitates assembly by increasing the bearing surface area of the base (or the support) of the press on the mount during pressing.

FIG. 19 shows an alternative embodiment of the invention also applied to the vicinity of the end of an optical fiber. The mount 403 has the shape of a tube made up of two cylindrical parts: a narrow front part 409 and a wider back part 4032. The cladding 4020 can slide in the cylindrical bore 408 of said narrow part, whose diameter is slightly greater than that of said cladding. The optical fiber covered with a protective sheath 4021 and possibly also a buffer, extends in part to the level of the wider back part 4032 of the mount in a cylindrical bore 4030 of diameter greater than that of said cladding or of said buffer (not shown). The ring 404 has a frustoconical inside face 4010 resting against the cylindrical narrow part 409 of the mount. Thus, during the longitudinal displacement of the mount relative to the ring, said cylindrical narrow face 409 of the mount is designed to swage and wedge the cladding 4020 of the fiber.

FIGS. 20 and 21 show the same embodiments of the invention as those shown in FIGS. 18 and 19, respectively, applied to the cladding 3020/4020 of an optical fiber between two portions covered with a protective sheath 3021/4021 (whose diameter is generally 250 μm for silica optical fibers but can be 400 μm for certain polarization-maintaining fibers). The diameter of the front cylindrical bore 308/408 of the mount 303/403 is slightly greater than the diameter of the protective sheath 3021/4021, so as to enable insertion of the optical fiber up to its cladding 3020/4020. The ring 304/404 and the mount 303/403 are of a size such that the cladding 3020/4020 is wedged in place in said mount 303/403 after said ring 304/404 has been set into place.

By way of an example, the sheath of a (silica-based) optical fiber with a diameter of 0.125 mm±0.5 microns was placed in a brass mount having a bore of the same diameter (tolerance +5/+11 microns); a brass ring containing a conical bore (taper 1.5° and 2.4 mm outside diameter) was placed around the cylindrical outside face of the mount (1 mm outside diameter); an axial force lying in the range 50 N to 400 N was applied to cause all three parts to be secured mutually by friction.

In order to prevent any matter or metal deposits being torn away from the interfaces when heliumtightness or watertightness is required, a long thin deformable ring 40 (FIG. 22) can be inserted between the mount 3 the component 2.

When the optical component is sufficiently long, and in order to avoid the mount being clamped too tightly along its length which could have detrimental effects on optical characteristics, it is possible to insert two thin and narrow deformable rings 40 (FIG. 23), or a single thin and narrow ring 40 (FIG. 24), or a thin and narrow ring 40 as well as a narrow annular projection 41 (FIG. 25) integrated into the mount 3, between the mount and the component 2.

FIGS. 26 to 28 show a variant embodiment of the invention in which the mount 203 has a narrow part 2031 containing a cavity 208 in the shape of a rectangular block with a rectangular base, of height and width that are slightly greater than those of the optical component 202 that it houses, which component is also in the form of a rectangular block with a rectangular base. The outside face 209 of the mount 203 and inside face 210 of the ring 204 are frustoconical with similar taper angles. The narrow part 2031 of the mount 203 is extended (longitudinally) by a wide part 2032 whose flat face 2033 borders the narrow part 2031 and functions as an abutment and support for the optical component 202, thus simplifying precise positioning of the component in the mount.

Once the mount has been force fitted into the ring, it clamps on the periphery of the component by swaging of the cavity 208.

FIG. 29 is a cross section (perpendicular to the axis of revolution of the mount or the ring). It shows a variant embodiment of the invention in which the optical component 102 is a rectangular block with a rectangular base and the cavity 108 of the mount 103 is cylindrical with a circular outline. The diameter (before assembly) of said cavity 108 slightly greater than the diagonal (in the section plane) of the optical component 102. Said cavity narrows during assembly due to the action of the ring 104 clamping around the corners of said optical component. This configuration is advantageous when heliumtightness or watertightness is not required because a cylindrical bore of circular outline is generally easier to manufacture than a rectangular bore. However, if the irregular radial stress imposed on the component is too strong, it can cause birefringence. Said stress must therefore be monitored.

FIGS. 30 to 35 show two embodiments of the invention in which the mount consists of two distinct elements.

In the explanation concerning these examples, semi-cylindrical signifies having the shape of a half cylinder when in section in a plane containing its axis.

In FIGS. 30 to 33, both elements 1103a and 1103b forming the mount are identical. They consist of a thin outside face 11031a and 11031b of semi-cylindrical shape extended by a flange also of semi-cylindrical shape 11032a and 11032b, of a contact face 11035a and 11035b allowing the two elements to be held against each other along their length, and of semi-cylindrical grooves 1108a and 1108b constituting respective half cavities; the semi-cylinders share a common axis. A tool 1160 whose coefficient of expansion is greater than that of the two elements and whose material is also substantially more ductile, contains a cylindrical cavity 1161 of a slightly smaller diameter than that of the flanges 11032a and 11032b. The tool is heated until its diameter is greater than that of the flanges of the two elements. After placing the cladding 11020 of an optical fiber in the grooves 1108a and 1108b, the elements 1103a and 1103b are joined, pressed together against the contact face 11035a and 11035b, then introduced into the cavity 1161 until reaching the abutment 1162. On cooling, the tool 1160 clamps together the two parts 1103a and 1103b which are then secured via their contact faces 11035a and 11035b. The facing grooves 1108a and 1108b create a closed cylindrical cavity into which the cladding 11020 can slide. The thin outside portions 11031a and 11031b of the elements joined in this way are then positioned against the frustoconical inside face 11010 of the ring 1104. The mount formed by the two elements is then force fitted into the ring and swaged, thereby wedging the cladding 11020. The tool 1160 is then heated in order to release the flanges 11032a and 11032b from the cavity 1161, while the two elements 1103a and 1103b, the component 11020, and the ring 1104 remain secured to one another.

This alternative is useful when the diameter of the cavity of the mount (for a mount as a single piece), needs to be substantially greater than that of the component. This applies, for example, to optical fibers equipped with a connector at one end and a capillary tube at the other end. If the mount holds only one component, the cavity diameter would have to be greater than that of the capillary tube or of the connector, in order to enable the optical fiber being threaded therein. Uniform swaging of the mount would then become difficult, if not impossible, whereby attempting to achieve a secure fixing of the optical fiber could cause it to break and/or be deformed randomly.

In FIGS. 34 and 35, the grooves 1208a and 1208b of the two elements 1203a and 1203b are half rectangular blocks (in section on a plane parallel to one face) and are designed to receive a rectangular component 1202 (filter, insulator, window, lens, or mirror). The outside faces 1209a and 1209b of the two elements 1203a and 1203b are semi-cylindrical. When in contact via their respective faces 12035a and 12035b, they are partially introduced into the cavity 1261 of the tool 1260. The frustoconical inside face 12010 of the ring 1204 rests against the cylindrical outside face of the two elements joined together outside the tool, in order to swage the cavity formed by the two grooves 1219a and 1219b around the component 1202.

This alternative is advantageous when the component is in the form of a rectangular block and when a cavity fitting this shape cannot easily be created in the mount.

FIGS. 36 and 37 show an embodiment of the invention, in which the mount 1303 comprises three countersunk holes, each with a cylindrical narrow part 1308a, 1308b, 1308c housing the cladding 13020a, 13020b, 13020c of an optical fiber and is extended at the back by a cylindrical wider part 13019a (not shown), 13019b, 13019c (not shown), housing the protective sheath 13021a (not shown), 13021b, 13021c (not shown) of said optical fiber. The inside face of the ring 1304 and the outside face of the mount 1303 are frustoconical, of approximately the same taper angle, so that once the mount is force fitted into the ring, each narrow part 1308a, 1308b, 1308c of each countersunk hole is compressed to block each cladding 13020a, 13020b, 13020c.

In the embodiment shown in FIG. 38, a portion of the thick-walled structure 704 constitutes three interference fit rings of three mounts respectively 703a, 703b, 703c for fixing the cladding 720a, 720b, 720c of three optical fibers lying in parallel.

The two preceding embodiments of the invention are not limited to three optical fibers and can be applied to other components. They are advantageous for attaching, for example, flat sheets of optical fibers or arrays of lenses in a wavelength-division multiplexer, switches, or other systems requiring the entrance and/or the exit of a plurality of optical channels.

FIGS. 39 and 40 show two examples of uses of the invention to align and secure a lens and the end of an optical fiber. The role of each device shown in these figures can be, for example, to focus the beam coming from an optical fiber onto a detector by means of a lens, or to collimate the beam coming from a fiber.

The optical fiber 802 and the lens 902 must be positioned longitudinally (along the axis 1) and must be aligned transversally in order to perform their function correctly. In the example shown in FIG. 15, the mount 903 is secured to the lens 902 and to the ferrule 25 (containing the fiber 802), which abuts against two retaining structures 9040 and 9041, defining the longitudinal distance between the two optical components. In addition, the mechanical elements used (mounts and rings) have inside and outside faces that are sufficiently concentric to allow good transverse alignment of the components 802 and 902.

The fiber 802 is held in the ferrule 25 by a conical mount crimped using the embodiment shown in FIG. 18.

The lens 902 is assembled to abut an annular portion of the mount 903 forming an inside flange at its bore.

The mount 903 (whose outside is conical) is deformed by being force fitted into the ring 904 having a conical bore. Due to the size and tolerance of the elements 902, 903, 904, when the mount 903 arrives against the retaining structure 9040 it is sufficiently deformed to hold the lens 902 securely.

In FIG. 35 an additional conical mount 9030 is provided between the ferrule 25 and the ring 904. Said mount 9030 is fitted into the ring 904, once the ferrule 25 has abutted against the retaining structure 9041, until the ferrule is held securely.

Another technique (shown in FIG. 40) can be used to ensure precise longitudinal spacing between the fiber 802 and the lens 1002, for example, when the tolerance of positioning the abutments 10040 and 10041 of the ring 1004 is not sufficient. In this case, a ferrule 25 is inserted into the main ring 1004, then a second conical ring 1104 is fitted on the main ring 1004 until the ferrule 25 is able to slide without clearance into the bore 10042 of the main ring. The positioning of the ferrule is adjusted to obtain the best position. The conical ring 1104 is then force fitted so as to block the ferrule 25 in its best position. Due to lack of clearance for sliding, the ferrule 25 does not move relative to the lens 1002 during the blocking action; these techniques enable the desired spacing between the components 802, 1002 to be obtained with an accuracy of a few microns.

Thus, in this embodiment, an annular front portion 10043 of one end of the part 1004 forms a securing ring in the mount 1003, while an annular back portion 10044 of the other end of the part 1004 forms a deformable mount for fixing the ferrule 25 due to the pressure exerted by the additional ring 1104.

With reference to FIG. 42, the assemblies of the invention can be used to make an optical device 32 inside a hermetic package 26, 27, comprising: a laser diode 28, a lens 29 to collimate the beam produced by the diode, an isolator 30, and a focusing lens 31; a ferrule 25 into which extends an optical fiber 802, passes through an opening in the wall 26 of the package.

1/ A method of fixing an optical component (2, 102, 202, 502, 602, 720a, 720b, 720c, 802, 902, 1002, 1202, 3020, 4020, 11020, 13020a, 13020b, 13020c) to a mount, in which said component is engaged in a deformable mount (3, 103, 203, 303, 403, 503, 603, 703a, 703b, 703c, 803, 903, 1003, 1103a/1103b, 1203a/1203b, 1303), said mount is then deformed to secure it to said component, the method being characterized in that the mount is maintained in the deformed state by a ring (4, 104, 204, 304, 404, 504, 604, 704, 804, 904, 1004, 1104, 1204, 1304) encircling the mount.

2/ A method of fixing an optical component (2, 102, 202, 502, 602, 720a, 720b, 720c, 802, 902, 1002, 1202, 3020, 4020, 11020, 13020a, 13020b, 13020c) in a cavity provided in a first part—called a mount—, by deforming the first part (3, 103, 203, 303, 403, 503, 603, 703a, 703b, 703c, 803, 903, 1003, 1103a/1103b, 1203a/1203b, 1303) and swaging the cavity (8, 108, 208, 308, 408, 1108a/1108b, 1308a/1308b/1308c) until the component is fixed by friction on a face of closed outline defining the cavity, at least in part, the method being characterized in that a second part is placed around at least a portion of the first part, the second part comprising a ring (4, 104, 204, 304, 404, 504, 604, 704, 804, 904, 1004, 1104, 1204, 1304) which clamps the first part, thereby causing and/or maintaining said compression, so that the component and said first and second parts are simultaneously assembled together, by friction between the component and the first part, and by friction between the first part and the second part.

3/ A method according to claim 1 or claim 2, in which said first part or mount, and/or said second part or ring is caused to cool down.

4/ A method according to any one of claims 1 to 3, in which swaging of the first part or mount results, in part at least, from a bearing force exerted progressively on an outside face (9, 209, 309, 11031a/11031b, 1209a/1209b) of said first part or mount, by an inside face (10, 210, 3010, 4010, 11010, 12010) of said second part or ring.

5/ A method according to claim 4, in which said ring or second part is placed around said mount or first part so that their longitudinal axes coincide with the axis (1) of said optical component, and in which pressure is exerted on the ring or second part by maintaining the mount or first part pressed against an abutment (14, 87), in order to cause a relative longitudinal displacement of said first and second parts along an axis (16) until the ring is wedged around the mount and the mount is wedged around said component.

6/ A method according to claim 5, wherein said pressure is measured, and the application of said pressure is stopped when it has reached a predetermined value.

7/ A method according to claim 5, wherein the relative longitudinal displacement of said first and second parts is stopped when the punch abuts against an abutment.

8/ A method according to any preceding claim, in which assembling together the optical component, said first part or mount, and said second part or ring, generates radial deformation of said ring demonstrating that the stresses imposed on it are greater than the elastic limit of the material of which it is composed.

9/ An optical or opto-electronic device comprising at least one optical component (2, 102, 202, 502, 602, 720a, 720b, 720c, 802, 902, 1002, 1202, 3020, 4020, 11020, 13020a, 13020b, 13020c) secured by friction to a first part or mount (3, 103, 203, 303, 403, 503, 603, 703a, 703b, 703c, 803, 903, 1003, 1103a/1103b, 1203a/1203b, 1303) into which it extends, at least in part, the device being characterized in that it also comprises a second part or ring (4, 104, 204, 304, 404, 504, 604, 704, 804, 904, 1004, 1104, 1204, 1304) encircling said first part or mount, so as to maintain the swaging of said first part or mount.

10/ A device according to claim 9 in which said first part or mount is secured to said second part or ring by friction.

11/ A device according to claim 10, in which said first part or mount includes a closed cavity (8, 108, 208, 308, 408, 1108a/1108b, 1308a/1308b/1308c) enclosing at least part of the optical component due to the swaging caused and/or maintained by the said second part or ring.

12/ A device according to claim 10, in which said first part or mount comprises a sleeve presenting a flared outside face (9, 209), in particular a frustoconical face, and in which said second part or ring presents a flared inside face (10, 210), in particular a frustoconical face.

13/ A device according to claim 10 in which said second part or ring presents a frustoconical inside face (10, 3010, 4010, 11010, 12010), said first part or mount comprising a sleeve whose outside face (9, 309, 11031a/11031b, 1209a/1209b) is cylindrical.

14/ A device according to claim 10, in which said first part or mount comprises a frustoconical outside face (9), said second part or ring having a cylindrical inside face (10).

15/ A device according to claim 10, in which said second part or ring has an outside face (11) of cylindrical shape.

16/ A device according to claims 12, 13 and 14, in which the half angle at the top (5, 6) of at least one said frustoconical faces (9, 209, 309, 11031a/11031b, 1209a/1209b, 10, 210, 3010, 4010, 11010, 12010) has a value in the range of 0.3° to 10°.

17/ A device according to claim 10, in which the respective inside and outside faces (10, 9) of said second part or ring and of said first part or mount, are cylindrical.

18/ A device according to claim 11, in which said closed cavity (8, 108, 308, 408, 1108a/1108b, 1308a/1308b/1308c) enclosing at least part of said optical component, is defined by a cylindrical outline.

19/ A device according to claim 18, in which the outside envelope of the optical component (2, 502, 602, 720a, 720b, 720c, 802, 902, 1002, 3020, 4020, 11020, 13020a, 13020b, 13020c) is cylindrical, said optical component being in particular cladding (720a, 720b, 720c, 3020, 4020, 11020, 13020a, 13020b, 13020c) at the end of an optical fiber or of an optical fiber segment located between two portions of its protective sheath (3021, 4021), a thick lens (2, 502, 602), a thin lens (2), a window (2), a filter, or a mirror.

20/ A device according to any one of claims 9 to 19, in which said first part or mount is made of a metallic material containing copper, zinc, iron, aluminum, nickel, gold, lead, tin, or indium which is at least as ductile as that of the ring, and/or in which the thickness of mount is no greater than that of said ring.

21/ A device according to claim 20 in which the elastic limit of the metal composing said first part or mount is greater than 15 MPa.

22/ A device according to claim 18, in which the optical component is a spherical lens (2).

23/ A device according to claim 11, in which the closed cavity (208, 1208a/1208b) of said first part or mount is of rectangular block shape with a rectangular base.

24/ A device according to claims 11 to 18, 20, 21, and 23, in which the optical component (102, 202, 1202) is of rectangular block shape with a rectangular base.

25/ A device according to any of the claims 11 to 24, in which said first part or mount consists of two identical elements (1103a, 1103b, 1203a, 1203b) presenting respective grooves (1108a, 1108b, 1208a, 1208b) and outside faces (11031a, 1131b, 1209a, 1209b), said elements being placed face to face and pressing against each other via their contact faces (11035a, 11035b, 12035a, 12035b), said grooves as joined in this way forming a cavity of closed outline, said outside faces of said elements being encircled by said second part or ring.

26/ A device according to claim 25, in which the groove (1108a, 1108b) of each element has a semi-cylindrical outline in section on a plane containing its axis.

27/ A device according to claim 25, in which the groove (1208a, 1208b) of each element has a outline whose shape is a half rectangular block in section on a plane parallel with one of its faces.

28/ A device according to any one of claims 9 to 27, in which one of said first or second parts, or mount or ring, includes a flange (3a, 4a, 303a, 11032a/11032b).

29/ A device according to claims 9 to 28 in which said first part or mount includes an abutment (33, 2033) for positioning the optical component longitudinally.

30/ A device according to any of the claims 9 to 29, which additionally includes at least one deformable ring (40) inserted between the mount and the component, and/or an annular projection (41) integrated in the mount.

31/ A device according to claims 11 to 30, in which said first part or mount set in said second part or ring, includes a plurality of parallel cavities (1308a, 1308b, 1308c), each enclosing an optical component (720a, 720b, 720c).

32/ A device according to claim 10, in which said component is an optical fiber (802) which is secured to a ferrule (25) set in said ring by an additional conical ring (1104).

33/ A device according to claim 10, in which said component is an optical fiber which is secured to a ferrule (25) by means of a deformable mount, the ferrule being secured to said ring.

34/ A device according to claim 10, 32, or 33, which includes a lens and an optical fiber, each of which being secured to the ring by swaging of a deformable annular mount, and in which said ring (1004) includes at least one abutment (10040, 10041) for positioning the lens and/or fiber longitudinally.

35/ A method according to claim 5, and claims 13 and 17, in which the inside face of said second part or ring is placed against the cylindrical outside face (9) of said first part or mount (3) whose lower face (17) was previously pushed against the upper face (87) of a cylindrical support (82) of approximately the same diameter as said mount and placed on the base (13) of the press, an annular sleeve (83) is placed around said support and said mount, and said sleeve is held in contact with the lower face (92) of said ring by means of an elastic element (84) pressing on the base (13) in order to constantly encircle said support and the portion of said mount (99) located under said lower face (92) of said ring.
